(19) United States
(12) Patent Application Publication
(10) Pub. No.: US 2026/0253571 A1
(43) Pub. Date: Aug. 27, 2026

(54) ACTIVE NOISE REDUCTION DEVICE

(71) Applicant: HONDA MOTOR CO., LTD., Tokyo (JP)

(72) Inventors: Xun WANG, Saitama (JP); Toshio INOUE, Saitama (JP); Takuma MAESAKA, Saitama (JP)

(21) Appl. No.: 19/541,693

(22) Filed: Feb. 17, 2026

(30) Foreign Application Priority Data
Feb. 27, 2025 (JP) 2025-029883

(51) Int. Cl. G10K 11/178

(52) U.S. Cl. CPC G10K 11/17823; G10K 11/17881; G10K 11/17883; G10K 11/17825; G10K 2210/12821; G10K 2210/3026; G10K 2210/3027; G10K 2210/3028; G10K 2210/3046; G10K 2210/501

(57) ABSTRACT

An active noise reduction device includes a canceling sound outputter configured to output a canceling sound for canceling a noise, a microphone configured to generate a microphone signal based on the noise, and a controller configured to control the canceling sound outputter based on the microphone signal. The controller includes at least one filter that can be adaptively updated, and the controller is configured to calculate a fluctuation of the microphone signal based on the microphone signal, and switch an operation of at least one of an adaptive update process and a canceling sound output process according to the fluctuation of the microphone signal. The adaptive update process is a process to adaptively update the filter, and the canceling sound output process is a process to cause the canceling sound outputter to output the canceling sound.

### TECHNICAL FIELD

The present invention relates to an active noise reduction device.

### BACKGROUND ART

Conventionally, a known active noise reduction device reduces a noise by causing a canceling sound in the opposite phase to the noise to interfere with the noise. The active noise reduction device includes a canceling sound outputter (for example, a speaker) that outputs a canceling sound for canceling a noise, and a controller that controls the canceling sound outputter based on an input signal (for example, a microphone signal or an acceleration signal) (see JP2023-144581A).

The active noise reduction device described above may not be able to stably and effectively reduce the noise in a case where the input signal contains a component with a large fluctuation (for example, if the microphone signal contains a sound component or the acceleration signal contains an instantaneous vibration component).

### SUMMARY OF THE INVENTION

In view of the above background, an object of the present invention is to provide an active noise reduction device that can stably and effectively reduce a noise even if an input signal contains a component with a large fluctuation.

To achieve such an object, one aspect of the present invention provides an active noise reduction device, comprising: a canceling sound outputter configured to output a canceling sound for canceling a noise; a microphone configured to generate a microphone signal based on the noise; and a controller configured to control the canceling sound outputter based on the microphone signal, wherein the controller includes at least one filter that can be adaptively updated, and the controller is configured to: calculate a fluctuation of the microphone signal based on the microphone signal; and switch an operation of at least one of an adaptive update process and a canceling sound output process according to the fluctuation of the microphone signal, the adaptive update process being a process to adaptively update the filter, the canceling sound output process being a process to cause the canceling sound outputter to output the canceling sound.

Another aspect of the present invention provides an active noise reduction device, comprising: a canceling sound outputter configured to output a canceling sound for canceling a noise; an acceleration sensor configured to generate an acceleration signal based on the noise; and a controller configured to control the canceling sound outputter based on the acceleration signal, wherein the controller includes at least one filter that can be adaptively updated, and the controller is configured to: calculate a fluctuation of the acceleration signal based on the acceleration signal; and switch an operation of at least one of an adaptive update process and a canceling sound output process according to the fluctuation of the acceleration signal, the adaptive update process being a process to adaptively update the filter, the canceling sound output process being a process to cause the canceling sound outputter to output the canceling sound.

Thus, according to the above aspects, it is possible to provide an active noise reduction device that can stably and effectively reduce a noise even if an input signal contains a component with a large fluctuation.

### BRIEF DESCRIPTION OF THE DRAWING(S)

FIG. 1 is a schematic diagram showing a vehicle to which an active noise reduction device according to an embodiment is applied;

FIG. 2 is a block diagram showing the active noise reduction device according to the embodiment;

FIG. 3A is a waveform chart showing the change in an amplitude of a microphone signal;

FIG. 3B is a waveform chart showing the change in a fluctuation of the microphone signal;

FIG. 4A is a waveform chart showing the change in an amplitude of an acceleration signal;

FIG. 4B is a waveform chart showing the change in a fluctuation of the acceleration signal;

FIG. 5 is a flowchart showing an execution example 1 of first switching control according to the embodiment;

FIG. 6 is a flowchart showing an execution example 2 of the first switching control according to the embodiment;

FIG. 7 is a graph showing setting lines of first and second μ tables according to the embodiment;

FIG. 8 is a graph showing setting lines of first and second n tables according to the embodiment;

FIG. 9 is a flowchart showing an execution example 1 of second switching control according to the embodiment;

FIG. 10 is a flowchart showing an execution example 2 of the second switching control according to the embodiment; and

FIG. 11 is a graph showing a setting line of a u table according to the embodiment.

### DETAILED DESCRIPTION OF THE INVENTION

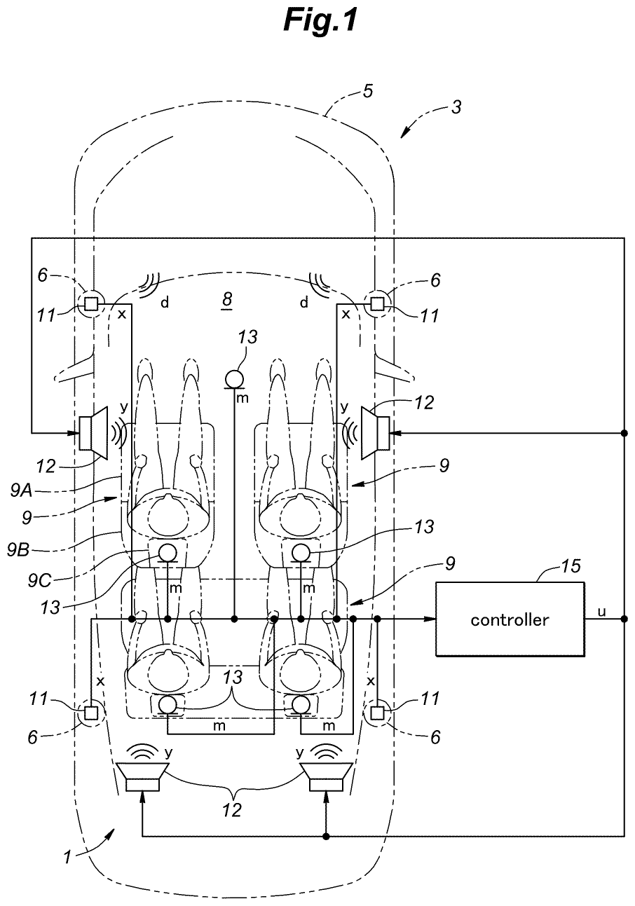

In the following, with reference to FIGS. 1 to 11, an active noise reduction device 1 (hereinafter abbreviated as “the noise reduction device 1”) according to an embodiment will be described. In this specification, “A” (circumflex) next to various symbols represents an identification value or an estimation value. “A” is arranged above various symbols in the drawings and formulas, but is arranged after various symbols in the following description. “AU” shown in some of the drawings represents an adaptive update.

### <Vehicle 3>

FIG. 1 is a schematic diagram showing a vehicle 3 to which the noise reduction device 1 is applied. The vehicle 3 includes a vehicle body 5, a plurality of wheels (not shown) arranged below the vehicle body 5, and a plurality of suspensions 6 arranged between the vehicle body 5 and the plurality of wheels. A vehicle cabin 8 is formed inside the vehicle body 5. The vehicle cabin 8 is provided with a plurality of occupant seats 9. Each occupant seat 9 includes a seat cushion 9A, a seat back 9B arranged above and behind the seat cushion 9A, and a headrest 9C fixed to the upper end of the seat back 9B.

### <Noise Reduction Device 1>

With reference to FIG. 1, the noise reduction device 1 is an ANC (Active Noise Control) device for reducing a noise d generated within the vehicle cabin 8 of the vehicle 3. More specifically, the noise reduction device 1 generates a canceling sound y that is in the opposite phase to the noise d, and reduces the noise d by causing the generated canceling sound y to interfere with the noise d.

The noise reduction device 1 includes a plurality of acceleration sensors 11 each configured to generate an acceleration signal x based on the noise d, a plurality of speakers 12 (an example of canceling sound outputters) each configured to output the canceling sound y for canceling the noise d, a plurality of microphones 13 each configured to generate a microphone signal m based on the noise d, and a controller 15 configured to control the plurality of speakers 12 based on the acceleration signal x and the microphone signal m.

### <Acceleration Sensor 11>

With reference to FIG. 1, each acceleration sensor 11 is installed in the corresponding suspension 6. The acceleration sensor 11 detects the acceleration of the suspension 6 according to the noise d, and generates the acceleration signal x according to the acceleration of the suspension 6. The acceleration signal x is used as a reference signal corresponding to the noise d.

### <Speaker 12>

With reference to FIG. 1, each speaker 12 is installed in a portion (for example, a door on the side of the occupant seat 9 or a space behind the occupant seat 9) of the vehicle 3 other than the occupant seat 9. In another embodiment, the speaker 12 may be installed in the occupant seat 9 (for example, the headrest 9C of the occupant seat 9).

### <Microphone 13>

With reference to FIG. 1, each microphone 13 is installed in the headrest 9C of the occupant seat 9 or the vicinity of a noise source. In another embodiment, the microphone 13 may be installed in a portion (for example, a ceiling above the occupant seat 9) of the vehicle 3 other than the occupant seat 9 or the vicinity of a noise source.

The microphone 13 is simultaneously used as a microphone configured to generate an error signal e corresponding to an error between the noise d and the canceling sound y, and as a microphone configured to generate a reference signal r corresponding to the noise d. In other words, the microphone signal m is simultaneously used as the error signal e and the reference signal r. For example, in a control channel whose control target is the speaker 12 adjacent to the driver's seat, the microphone 13 installed in the driver's seat generates the error signal e, and the microphone 13 installed in a seat other than the driver's seat or the vicinity of the noise source generates the reference signal r. By contrast, in a control channel whose control target is the speaker 12 adjacent to the passenger seat, the microphone 13 installed in the passenger seat generates the error signal e, and the microphone 13 installed in a seat other than the passenger seat or the vicinity of the noise source generates the reference signal r. Hereinafter, the microphone 13 configured to generate the error signal e will be referred to as “the error microphone 13e,” and the microphone 13 configured to generate the reference signal r will be referred to as “the reference microphone 13r”.

### <Controller 15>

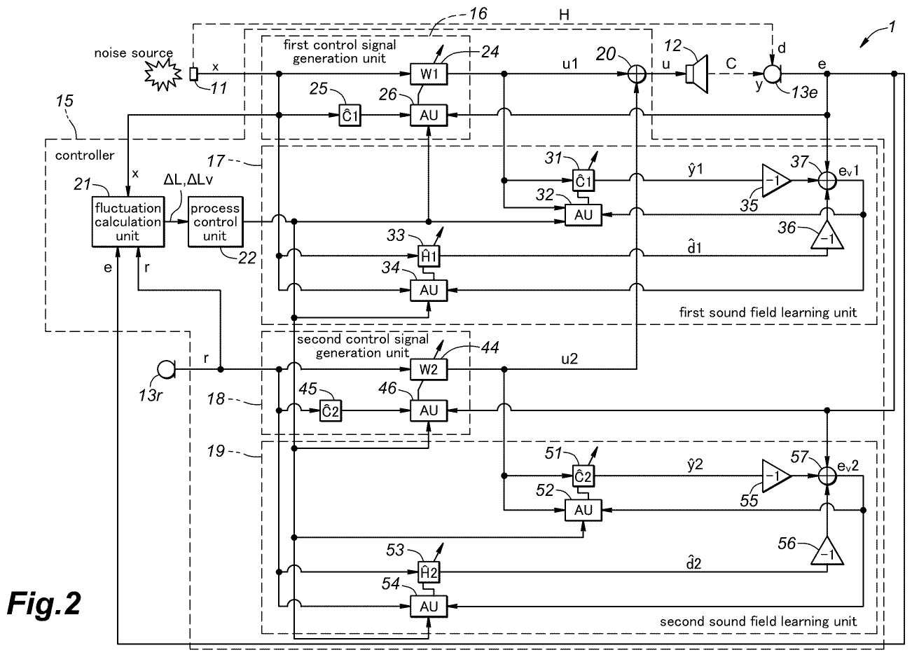

With reference to FIG. 2, the controller 15 is composed of a computer having an arithmetic processing unit (a processor such as a CPU or an MPU) and a storage unit (memory such as a ROM or a RAM). The controller 15 may be composed of a single piece of hardware, or may be composed of a unit including plural pieces of hardware.

The controller 15 includes, as the functional components thereof, a plurality of first control signal generation units 16, a plurality of first sound field learning units 17, a plurality of second control signal generation units 18, a plurality of second sound field learning units 19, a control signal adding unit 20, a fluctuation calculation unit 21, and a process control unit 22. The number of first control signal generation units 16 and the number of first sound field learning units 17 correspond to the number of acceleration sensors 11. The number of second control signal generation units 18 and the number of second sound field learning units 19 correspond to the number of reference microphones 13r. In FIG. 2, only one of the first control signal generation units 16, only one of the first sound field learning units 17, only one of the second control signal generation units 18, and only one of the second sound field learning units 19 are shown.

### <First Control Signal Generation Unit 16>

The acceleration signal x (reference signal) from the acceleration sensor 11 is input to each first control signal generation unit 16 of the controller 15. Each first control signal generation unit 16 includes a control filter unit 24, a reference signal correction unit 25, and a control update unit 26.

The control filter unit 24 includes a control filter W1. The control filter W1 is composed of an FIR filter (Finite Impulse Response filter). In another embodiment, the control filter W1 may be composed of a SAN filter (Single-frequency Adaptive Notch filter) and the like. The control filter unit 24 generates a first control signal u1 by executing a filtering process on the acceleration signal x (reference signal) using the control filter W1. The control filter unit 24 outputs the generated first control signal u1 to the first sound field learning unit 17 and the control signal adding unit 20.

The reference signal correction unit 25 includes a secondary path filter C\hat{ }1. The secondary path filter C\hat{ }1 is a filter that represents an estimation value of a transfer function C of a secondary path from the speaker 12 to the error microphone 13e. The secondary path filter C\hat{ }1 is composed of an FIR filter. In another embodiment, the secondary path filter C\hat{ }1 may be composed of a SAN filter and the like. The reference signal correction unit 25 corrects the acceleration signal x by executing a filtering process on the acceleration signal x (reference signal) using the secondary path filter C\hat{ }1. The reference signal correction unit 25 outputs the corrected acceleration signal x to the control update unit 26.

The control update unit 26 adaptively updates the control filter W1 using an adaptive algorithm such as an LMS algorithm (Least Mean Square algorithm). More specifically, the control update unit 26 adaptively updates the control filter W1 using the following formula (1) so that the error signal e output from the error microphone 13e is minimized.

$$W 1 ( t + 1 ) = η W 1 ( t ) - μ e ( t ) ( x ( t ) * \hat{C} 1 ( t ) ) \qquad ( 1 )$$

W1(t+1) in the above formula (1) represents the update value of the control filter W1 (the value of the control filter W1 after the adaptive update thereof), and W1(t) in the above formula (1) represents the current value of the control filter W1 (the value of the control filter W1 before the adaptive update thereof). In the above formula (1), e(t), x(t), and C\hat{ }1(t) represent the current value of the error signal e, the current value of the acceleration signal x, and the current value of the secondary path filter C\hat{ }1, respectively. “η” in the above formula (1) represents a parameter (hereinafter referred to as “the forgetting factor η”) for attenuating the control filter W1 and adjusting the magnitude of the first control signal u1 (u1=x*W1). As the forgetting factor η increases, the first control signal u1 and the canceling sound y increase. The forgetting factor η is set to a value between 0 and 1. “μ” in the above formula (1) is a parameter (hereinafter referred to as “the step size parameter μ”) for adjusting the magnitude of the update amount of the control filter W1 in each adaptive update of the control filter W1. As the step size parameter u increases, the update amount of the control filter W1 increases. The step size parameter u is set to a small positive number.

### <First Sound Field Learning Unit 17>

The acceleration signal x (reference signal) from the acceleration sensor 11 is input to each first sound field learning unit 17 of the controller 15. Each first sound field learning unit 17 includes a canceling sound estimation signal generation unit 31, a secondary path update unit 32, a noise estimation signal generation unit 33, a primary path update unit 34, a canceling sound estimation signal reversing unit 35, a noise estimation signal reversing unit 36, and a virtual error signal generation unit 37.

The canceling sound estimation signal generation unit 31, like the reference signal correction unit 25, includes the secondary path filter C\hat{ }1. The canceling sound estimation signal generation unit 31 generates a first canceling sound estimation signal y\hat{ }1 that represents an estimation value of the canceling sound y by executing a filtering process on the first control signal u1 using the secondary path filter C\hat{ }1. The canceling sound estimation signal generation unit 31 outputs the generated first canceling sound estimation signal y\hat{ }1 to the canceling sound estimation signal reversing unit 35.

The secondary path update unit 32 adaptively updates the secondary path filter C\hat{ }1 of the canceling sound estimation signal generation unit 31 using an adaptive algorithm such as an LMS algorithm. More specifically, the secondary path update unit 32 adaptively updates the secondary path filter C\hat{ }1 using the following formula (2) so that a first virtual error signal eᵥ1 (details will be described later) output from the virtual error signal generation unit 37 is minimized.

$$\hat{C} 1 ( t + 1 ) = η \hat{C} 1 ( t ) + μ {e}_{v} 1 ( t ) u 1 ( t ) \qquad ( 2 )$$

C\hat{ }1(t+1) in the above formula (2) represents the update value of the secondary path filter C\hat{ }1 (the value of the secondary path filter C\hat{ }1 after the adaptive update thereof), and C\hat{ }1(t) in the above formula (2) represents the current value of the secondary path filter C\hat{ }1 (the value of the secondary path filter C\hat{ }1 before the adaptive update thereof). In the above formula (2), eᵥ1(t) and u1(t) represent the current value of the first virtual error signal eᵥ1 and the current value of the first control signal u1, respectively. In the above formula (2), η and μ represent the forgetting factor η and the step size parameter μ, respectively.

Further, when the secondary path update unit 32 updates the secondary path filter C\hat{ }1 of the canceling sound estimation signal generation unit 31 as described above, the updated secondary path filter C\hat{ }1 may be output to the reference signal correction unit 25, and the secondary path filter C\hat{ }1 of the reference signal correction unit 25 may be updated.

The noise estimation signal generation unit 33 includes a primary path filter H\hat{ }1. The primary path filter H\hat{ }1 is a filter that represents an estimation value of a transfer function H of a primary path from the noise source to the error microphone 13e. The primary path filter H\hat{ }1 is composed of an FIR filter, for example. In another embodiment, the primary path filter H\hat{ }1 may be composed of a SAN filter and the like. The noise estimation signal generation unit 33 generates a first noise estimation signal d\hat{ }1 that represents an estimation value of the noise d by executing a filtering process on the acceleration signal x (reference signal) using the primary path filter H\hat{ }1. The noise estimation signal generation unit 33 outputs the generated first noise estimation signal d\hat{ }1 to the noise estimation signal reversing unit 36.

The primary path update unit 34 adaptively updates the primary path filter H\hat{ }1 using an adaptive algorithm such as an LMS algorithm. More specifically, the primary path update unit 34 adaptively updates the primary path filter H\hat{ }1 using the following formula (3) so that the first virtual error signal eᵥ1 (details will be described later) output from the virtual error signal generation unit 37 is minimized.

$$\hat{H} 1 ( t + 1 ) = η \hat{H} 1 ( t ) + μ {e}_{v} 1 ( t ) x ( t ) \qquad ( 3 )$$

H\hat{ }1(t+1) in the above formula (3) represents the update value of the primary path filter H\hat{ }1 (the value of the primary path filter H\hat{ }1 after the adaptive update thereof), and H\hat{ }1(t) in the above formula (3) represents the current value of the primary path filter H\hat{ }1 (the value of the primary path filter H\hat{ }1 before the adaptive update thereof). In the above formula (3), eᵥ1(t) and x(t) represent the current value of the first virtual error signal eᵥ1 and the current value of the acceleration signal x, respectively. In the above formula (3), η and μ represent the forgetting factor η and the step size parameter μ, respectively.

The canceling sound estimation signal reversing unit 35 reverses the polarity of the first canceling sound estimation signal y\hat{ }1 output from the canceling sound estimation signal generation unit 31. The canceling sound estimation signal reversing unit 35 outputs the first canceling sound estimation signal y\hat{ }1 with the polarity reversed to the virtual error signal generation unit 37.

The noise estimation signal reversing unit 36 reverses the polarity of the first noise estimation signal d\hat{ }1 output from the noise estimation signal generation unit 33. The noise estimation signal reversing unit 36 outputs the first noise estimation signal d\hat{ }1 with the polarity reversed to the virtual error signal generation unit 37.

The virtual error signal generation unit 37 generates the first virtual error signal eᵥ1 by adding together the error signal e output from the error microphone 13e, the first canceling sound estimation signal y\hat{ }1 that has passed through the canceling sound estimation signal reversing unit 35, and the first noise estimation signal d\hat{ }1 that has passed through the noise estimation signal reversing unit 36. The virtual error signal generation unit 37 outputs the generated first virtual error signal eᵥ1 to the secondary path update unit 32 and the primary path update unit 34.

### <Second Control Signal Generation Unit 18>

The reference signal r from the reference microphone 13r is input to each second control signal generation unit 18 of the controller 15. Each second control signal generation unit 18 includes a control filter unit 44, a reference signal correction unit 45, and a control update unit 46. The components of the second control signal generation unit 18 are similar to the components of the first control signal generation unit 16. Hereinafter, the second control signal generation unit 18 will be described, focusing only on the differences from the first control signal generation unit 16.

The control filter unit 44 generates a second control signal u2 by executing a filtering process on the reference signal r (the reference signal output from the reference microphone 13r) using a control filter W2. The control filter unit 44 outputs the generated second control signal u2 to the second sound field learning unit 19 and the control signal adding unit 20.

The reference signal correction unit 45 corrects the reference signal r (the reference signal output from the reference microphone 13r) by executing a filtering process on the reference signal r using a secondary path filter C\hat{ }2. The reference signal correction unit 45 outputs the corrected reference signal r to the control update unit 46.

The control update unit 46 adaptively updates the control filter W2 using the following formula (4) so that the error signal e output from the error microphone 13e is minimized.

$$W 2 ( t + 1 ) = η W 2 ( t ) - μ e ( t ) ( r ( t ) * \hat{C} 2 ( t ) ) \qquad ( 4 )$$

### <Second Sound Field Learning Unit 19>

The reference signal r from the reference microphone 13r is input to each second sound field learning unit 19 of the controller 15. Each second sound field learning unit 19 includes a canceling sound estimation signal generation unit 51, a secondary path update unit 52, a noise estimation signal generation unit 53, a primary path update unit 54, a canceling sound estimation signal reversing unit 55, a noise estimation signal reversing unit 56, and a virtual error signal generation unit 57. The components of the second sound field learning unit 19 are similar to the components of the first sound field learning unit 17. Hereinafter, the second sound field learning unit 19 will be described, focusing only on the differences from the first sound field learning unit 17.

The canceling sound estimation signal generation unit 51 generate a second canceling sound estimation signal y\hat{ }2 that represents an estimation value of the canceling sound y by executing a filtering process on the second control signal u2 using the secondary path filter C\hat{ }2. The canceling sound estimation signal generation unit 51 outputs the generated second canceling sound estimation signal y\hat{ }2 to the canceling sound estimation signal reversing unit 55.

The secondary path update unit 52 adaptively updates the secondary path filter C\hat{ }2 using the following formula (5) so that a second virtual error signal eᵥ2 (details will be described later) output from the virtual error signal generation unit 57 is minimized.

$$\hat{C} 2 ( t + 1 ) = η \hat{C} 2 ( t ) + μ {e}_{v} 2 ( t ) u 2 ( t ) \qquad ( 5 )$$

The noise estimation signal generation unit 53 generates a second noise estimation signal d\hat{ }2 that represents an estimation value of the noise d by executing a filtering process on the reference signal r (the reference signal output from the reference microphone 13r) using a primary path filter H\hat{ }2. The noise estimation signal generation unit 53 outputs the generated second noise estimation signal d\hat{ }2 to the noise estimation signal reversing unit 56.

The primary path update unit 54 adaptively updates the primary path filter H\hat{ }2 using the following formula (6) so that the second virtual error signal eᵥ2 (details will be described later) output from the virtual error signal generation unit 57 is minimized.

$$\hat{H} 2 ( t + 1 ) = η \hat{H} 2 ( t ) + {μ}_{} {e}_{v} 2 ( t ) r ( t ) \qquad ( 6 )$$

The canceling sound estimation signal reversing unit 55 reverses the polarity of the second canceling sound estimation signal y\hat{ }2 output from the canceling sound estimation signal generation unit 51. The canceling sound estimation signal reversing unit 55 outputs the second canceling sound estimation signal y\hat{ }2 with the polarity reversed to the virtual error signal generation unit 57.

The noise estimation signal reversing unit 56 reverses the polarity of the second noise estimation signal d\hat{ }2 output from the noise estimation signal generation unit 53. The noise estimation signal reversing unit 56 outputs the second noise estimation signal d\hat{ }2 with the polarity reversed to the virtual error signal generation unit 57.

The virtual error signal generation unit 57 generates the second virtual error signal eᵥ2 by adding together the error signal e output from the error microphone 13e, the second canceling sound estimation signal y\hat{ }2 that has passed through the canceling sound estimation signal reversing unit 55, and the second noise estimation signal d\hat{ }2 that has passed through the noise estimation signal reversing unit 56. The virtual error signal generation unit 57 outputs the generated second virtual error signal eᵥ2 to the secondary path update unit 52 and the primary path update unit 54.

### <Control Signal Adding Unit 20>

The control signal adding unit 20 of the controller 15 generates a control signal u for controlling the speaker 12 by adding together the first control signal u1 output from each of the first control signal generation units 16 and the second control signal u2 output from each of the second control signal generation units 18. The control signal adding unit 20 outputs the generated control signal u to the speaker 12. When the control signal u is input to the speaker 12, the speaker 12 generates the canceling sound y according to the magnitude of the control signal u.

### <Fluctuation Calculation Unit 21>

The fluctuation calculation unit 21 of the controller 15 receives the error signal e from the error microphone 13e and also receives the reference signal r from each of the reference microphones 13r. That is, the fluctuation calculation unit 21 receives the microphone signal m from each of the microphones 13. The fluctuation calculation unit 21 calculates a fluctuation ΔL of the microphone signal m based on the microphone signal m. More specifically, the fluctuation calculation unit 21 calculates the fluctuation ΔL of the microphone signal m by the following formula (7).

$$Δ L ( t ) = \frac{{\sum }_{t = t 1}^{t 2} \vert m ( t ) \vert}{{\sum }_{t = t 1}^{t 2} \vert m ( t - 1 ) \vert} \qquad ( 7 )$$

“t” in the above formula (7) represents discrete time. As is clear from the above formula (7), the fluctuation ΔL of the microphone signal m is defined as the ratio of the current magnitude of the microphone signal m to the previous magnitude of the microphone signal m. The magnitude of the microphone signal m is defined as the integrated value of the amplitude of the microphone signal m for each prescribed period. That is, the fluctuation ΔL of the microphone signal m is the fluctuation of the integrated value of the amplitude of the microphone signal m for each prescribed period.

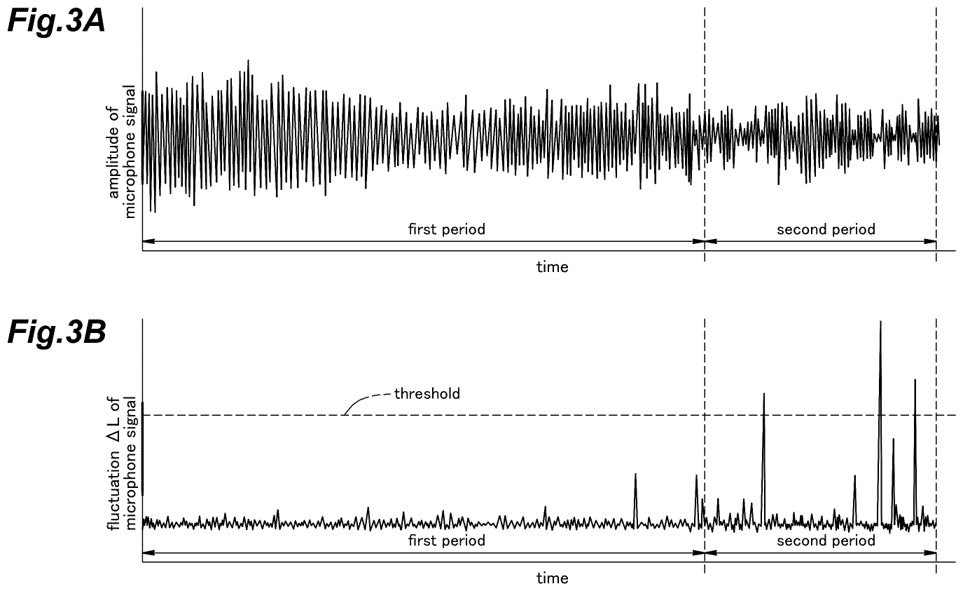

The first period in FIGS. 3A and 3B represents a period during which the proportion of a travel noise component in the microphone signal m is large (for example, a period during which the vehicle 3 is traveling on a rough road surface). By contrast, the second period in FIGS. 3A and 3B represents a period in which the proportion of the travel noise component in the microphone signal m is small (for example, a period in which the vehicle 3 is traveling on a flat road surface). As shown in FIG. 3B, even if the occupant of the vehicle 3 talks loudly in the first period, the fluctuation ΔL of the microphone signal m does not change significantly. This is because the noise component coming from the road surface is dominant, so the influence of conversation is small. By contrast, as shown in FIG. 3B, when the occupant of the vehicle 3 talks loudly in the second period, the fluctuation ΔL of the microphone signal m increases sharply. Accordingly, it is possible to accurately determine whether a sound component has mixed into the microphone signal m depending on whether the fluctuation ΔL of the microphone signal m exceeds a threshold.

With reference to FIG. 2, the fluctuation calculation unit 21 receives the acceleration signal x from each of the acceleration sensors 11. The fluctuation calculation unit 21 calculates the fluctuation ΔLv of the acceleration signal x based on the acceleration signal x. More specifically, the fluctuation calculation unit 21 calculates the fluctuation ΔLv of the acceleration signal x by the following formula (8).

$$Δ Lv ( t ) = \frac{{\sum }_{t = t 1}^{t 2} \vert x ( t ) \vert}{{\sum }_{t = t 1}^{t 2} \vert x ( t - 1 ) \vert} \qquad ( 8 )$$

“t” in the above formula (8) represents discrete time. As is clear from the above formula (8), the fluctuation ΔLv of the acceleration signal x is defined as the ratio of the magnitude of the current acceleration signal x to the magnitude of the previous acceleration signal x. The magnitude of the acceleration signal x is defined as the integrated value of the amplitude of the acceleration signal x for each prescribed period. That is, the fluctuation ΔLv of the acceleration signal x is the fluctuation of the integrated value of the amplitude of the acceleration signal x for each prescribed period.

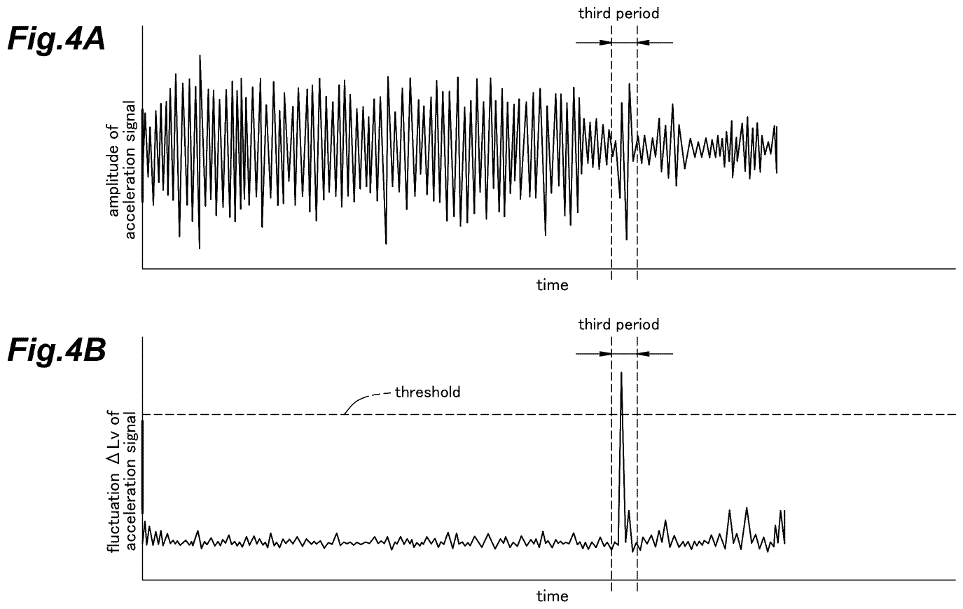

The third period in FIGS. 4A and 4B represents a period during which an instantaneous change occurs on the road surface (for example, a period during which the vehicle 3 goes over a bump, a road joint, a road hump, and the like). As shown in FIG. 4A, even if the instantaneous change occurs on the road surface in the third period, the amplitude of the acceleration signal x does not change as much as in the other periods. Accordingly, it is difficult to accurately determine whether an instantaneous vibration component has mixed into the acceleration signal x based on the amplitude of the acceleration signal x. By contrast, as shown in FIG. 4B, when the instantaneous change occurs on the road surface in the third period, the fluctuation ΔLv of the acceleration signal x changes more than in the other periods. Accordingly, it is possible to accurately determine whether the instantaneous vibration component has mixed into the acceleration signal x depending on whether the fluctuation ΔLv of the acceleration signal x exceeds a threshold.

### <Process Control Unit 22>

With reference to FIG. 2, the process control unit 22 of the controller 15 controls an adaptive update process and a canceling sound output process by transmitting the prescribed signals (for example, the signals related to the step size parameter u and the forgetting factor η) to the control update unit 26, the secondary path update unit 32, the primary path update unit 34, the control update unit 46, the secondary path update unit 52, and the primary path update unit 54. The adaptive update process is a process to adaptively update the control filter W1, the secondary path filter C\hat{ }1, the primary path filter H\hat{ }1, the control filter W2, the secondary path filter C\hat{ }2, and the primary path filter H\hat{ }2 (hereinafter referred to as “the adaptive update filters W1 to H\hat{ }2”). The canceling sound output process is a process to cause the speaker 12 to output the canceling sound y.

The process control unit 22 acquires the fluctuation ΔL of the microphone signal m and the fluctuation ΔLv of the acceleration signal x from the fluctuation calculation unit 21. The process control unit 22 switches the operation of the adaptive update process and the operation of the canceling sound output process according to the fluctuation ΔL of the microphone signal m and the fluctuation ΔLv of the acceleration signal x. Hereinafter, the control that switches the operation of the adaptive update process and the operation of the canceling sound output process according to the fluctuation ΔL of the microphone signal m will be referred to as “the first switching control”, and the control that switches the operation of the adaptive update process and the operation of the canceling sound output process according to the fluctuation ΔLv of the acceleration signal x will be referred to as “the second switching control”.

### Execution Example 1 of the First Switching Control

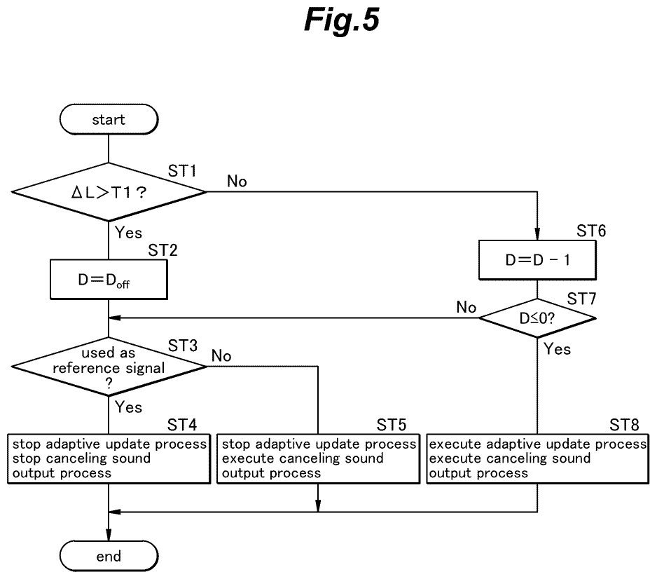

With reference to FIG. 5, when the first switching control is started, the process control unit 22 acquires the fluctuation ΔL of the microphone signal m from the fluctuation calculation unit 21 and determines whether the fluctuation ΔL of the microphone signal m exceeds a first threshold T1 (step ST1).

In a case where the fluctuation ΔL of the microphone signal m exceeds the first threshold T1 (step ST1: Yes), the process control unit 22 determines that the sound component has mixed into the microphone signal m and sets a count value D to D_{off} (step ST2). The count value D is set to an initial value of 0 at the start of the first switching control. The count value D is not reset even after the first switching control ends, but continues to be used in the next first switching control. D_{off} is a preset parameter and is set to a positive number greater than 1.

Next, the process control unit 22 determines whether the microphone signal m (more specifically, the microphone signal m whose fluctuation ΔL has been acquired from the fluctuation calculation unit 21 in step ST1) is being used as the reference signal r (step ST3).

In a case where the microphone signal m is being used as the reference signal r (step ST3: Yes), the process control unit 22 stops the adaptive update process to prevent the adaptive update filters W1 to H\hat{ }2 from being adaptively updated based on the microphone signal m into which the sound component has mixed. Further, the process control unit 22 stops the canceling sound output process to prevent the canceling sound y from being output based on the microphone signal m into which the sound component has mixed (step ST4).

In a case where the microphone signal m is not being used as the reference signal r (step ST3: No), the process control unit 22 stops the adaptive update process to prevent the adaptive update filters W1 to H\hat{ }2 from being adaptively updated based on the microphone signal m into which the sound component has mixed. By contrast, in a case where the microphone signal m into which the sound component has mixed is not used as the reference signal r, the sound component has not mixed into the reference signal r, so it is acceptable to continue outputting the canceling sound y with the control filters W1, W2 set as fixed filters (with the adaptive update of the control filters W1, W2 stopped). For example, for the control channel that uses the acceleration signal x as the reference signal, the output of the canceling sound y may be continued. Accordingly, the process control unit 22 executes the canceling sound output process with the control filters W1, W2 set as fixed filters, thereby causing the speaker 12 to output the canceling sound y (step ST5).

In a case where the fluctuation ΔL of the microphone signal m is equal to or less than the first threshold T1 (step ST1: No), the process control unit 22 subtracts 1 from the count value D (step ST6) and determines whether the count value D is equal to or less than 0 (step ST7).

In a case where the count value D is not equal to or less than 0 (step ST7: No), the process control unit 22 determines whether the microphone signal m is being used as the reference signal r (step ST3).

In a case where the count value D is equal to or less than 0 (step ST7: Yes), the process control unit 22 executes the adaptive update process to adaptively update the adaptive update filters W1 to H\hat{ }2. The process control unit 22 also executes the canceling sound output process to cause the speaker 12 to output the canceling sound y (step ST8).

Further, after it is determined in the first switching control that the fluctuation ΔL of the microphone signal m exceeds the first threshold T1 and the adaptive update process is stopped, it may be determined in the next first switching control that the fluctuation ΔL of the microphone signal m is equal to or less than the first threshold T1. Even in such a case, the adaptive update process is not immediately restarted, but remains stopped until the period corresponding to D_{off} elapses (see step ST7). Accordingly, it is possible to prevent the adaptive update process from being frequently switched on and off in a short period.

### Execution Example 2 of the First Switching Control

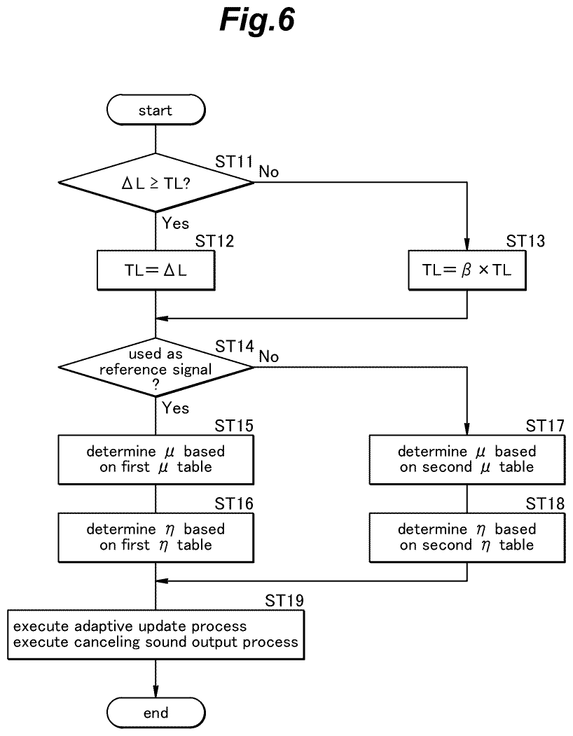

With reference to FIG. 6, when the first switching control is started, the process control unit 22 acquires the fluctuation ΔL of the microphone signal m from the fluctuation calculation unit 21 and determines whether the fluctuation ΔL of the microphone signal m is equal to or more than a reference fluctuation TL (step ST11). The reference fluctuation TL is a fluctuation for table reference. The reference fluctuation TL is not reset even after the first switching control ends, but is continuously used in the next first switching control.

In a case where the fluctuation ΔL of the microphone signal m is equal to or more than the reference fluctuation TL (step ST11: Yes), the process control unit 22 sets the reference fluctuation TL to the fluctuation ΔL (step ST12).

In a case where the fluctuation ΔL of the microphone signal m is less than the reference fluctuation TL (step ST11: No), the process control unit 22 sets the reference fluctuation TL to β×TL (step ST13). “β” is a preset parameter, and is set to a positive number smaller than 1.

Next, the process control unit 22 determines whether the microphone signal m (more specifically, the microphone signal m whose fluctuation ΔL has been acquired from the fluctuation calculation unit 21 in step ST11) is being used as the reference signal r (step ST14).

In a case where the microphone signal m is being used as the reference signal r (step ST14: Yes), the process control unit 22 determines the step size parameter μ based on the reference fluctuation TL set in step ST12 or step ST13 and a first μ table showing the relationship between the reference fluctuation TL and the step size parameter μ (step ST15). The first μ table will be described in detail later.

Further, the process control unit 22 determines the forgetting factor η based on the reference fluctuation TL set in step ST12 or step ST13 and a first n table showing the relationship between the reference fluctuation TL and the forgetting factor η (step ST16). The first n table will be described in detail later.

In a case where the microphone signal m is not being used as the reference signal r (step ST14: No), the process control unit 22 determines the step size parameter μ based on the reference fluctuation TL set in step ST12 or step ST13 and a second μ table showing the relationship between the reference fluctuation TL and the step size parameter μ (step ST17). The second μ table will be described in detail later.

Further, the process control unit 22 determines the forgetting factor η based on the reference fluctuation TL set in step ST12 or step ST13 and a second n table showing the relationship between the reference fluctuation TL and the forgetting factor η (step ST18). The second η table will be described in detail later.

Next, the process control unit 22 adaptively updates the adaptive update filters W1 to H\hat{ }2 by executing the adaptive update process using the step size parameter μ and the forgetting factor η determined in steps ST15 to ST18 (see the above formulas (1) to (6)). Further, the process control unit 22 executes the canceling sound output process using the control filters W1, W2 that have been adaptively updated by the adaptive update process, thereby causing the speaker 12 to output the canceling sound y (step ST19).

As described above, the process control unit 22 sets the reference fluctuation TL based on the fluctuation ΔL of the microphone signal m, determines the step size parameter μ and the forgetting factor η based on the reference fluctuation TL, and executes the adaptive update process using the step size parameter μ and the forgetting factor η. Accordingly, the update amount of the adaptive update filters W1 to H\hat{ }2 in the adaptive update process (the second term on the right-hand side of the above formulas (1) to (6)) is changed according to the fluctuation ΔL of the microphone signal m, and the reflection amount of the current value of the adaptive update filters W1 to H\hat{ }2 in the update value of the adaptive update filters W1 to H\hat{ }2 in the adaptive update process (the first term on the right-hand side of the above formulas (1) to (6)) is changed.

Further, in a case where the fluctuation ΔL of the microphone signal m is less than the reference fluctuation TL, the process control unit 22 sets the reference fluctuation TL to β×TL, and determines the step size parameter μ by referring to the first μ table or the second μ table based on the reference fluctuation TL. Accordingly, it is possible to prevent the step size parameter μ from increasing suddenly in a case where the fluctuation ΔL of the microphone signal m becomes suddenly small. This effect is also exhibited for the forgetting factor η.

### <First μ Table and Second μ Table>

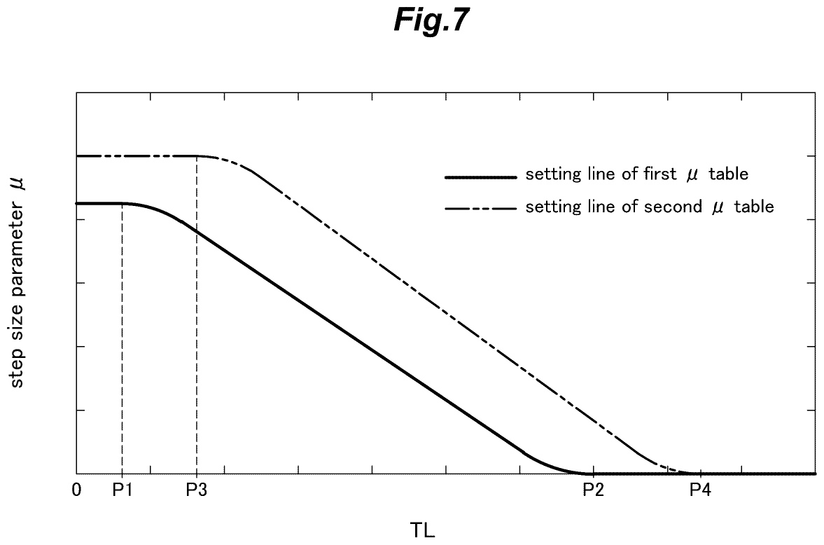

With reference to FIG. 7, in a case where the reference fluctuation TL is less than a reference value P1 in the first μ table, the step size parameter μ is kept at the maximum value thereof. In a case where the reference fluctuation TL is equal to or greater than the reference value P1 and is less than a reference value P2 that is greater than the reference value P1 in the first μ table, the step size parameter μ becomes smaller as the reference fluctuation TL increases. In a case where the reference fluctuation TL is equal to or greater than the reference value P2 in the first μ table, the step size parameter μ is kept at 0.

The step size parameter μ is set to a smaller value in the first μ table than in the second μ table except for a case where the step size parameter μ is 0. Accordingly, in a case where the step size parameter μ is determined based on the first μ table in step ST15, the step size parameter μ becomes smaller and the update amount of the adaptive update filters W1 to H\hat{ }2 in the adaptive update process becomes smaller than in a case where the step size parameter μ is determined based on the second μ table in step ST17. Accordingly, in a case where the microphone signal m is being used as the reference signal r, the update amount of the adaptive update filters W1 to H\hat{ }2 in the adaptive update process is reduced as compared to a case where the microphone signal m is not being used as the reference signal r.

In a case where the reference fluctuation TL is less than a reference value P3 in the second μ table, the step size parameter μ is kept at the maximum value thereof. In a case where the reference fluctuation TL is equal to or greater than the reference value P3 and is less than a reference value P4 that is greater than the reference value P3 in the second μ table, the step size parameter μ becomes smaller as the reference fluctuation TL increases. In a case where the reference fluctuation TL is equal to or greater than the reference value P4 in the second μ table, the step size parameter μ is kept at 0.

In a case where the reference fluctuation TL set based on the fluctuation ΔL of the microphone signal m is within the prescribed range in the first μ table and the second μ table, the step size parameter μ becomes continuously smaller as the reference fluctuation TL becomes larger. Accordingly, as the fluctuation ΔL of the microphone signal m increases, the step size parameter μ becomes smaller, and the update amount of the adaptive update filters W1 to H\hat{ }2 in the adaptive update process becomes smaller.

### <First η Table and Second η Table>

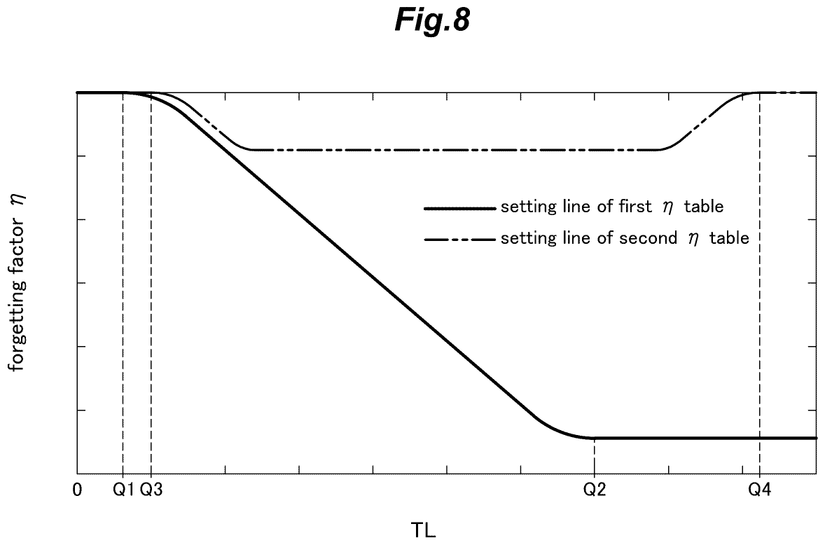

With reference to FIG. 8, in a case where the reference fluctuation TL is less than a reference value Q1 in the first η table, the forgetting factor η is kept at 1. In a case where the reference fluctuation TL is equal to or greater than the reference value Q1 and is less than a reference value Q2 that is greater than the reference value Q1 in the first η table, the forgetting factor η becomes smaller as the reference fluctuation TL increases. In a case where the reference fluctuation TL is equal to or greater than the reference value Q2 in the first η table, the forgetting factor η is kept at the minimum value.

The forgetting factor η is set to a smaller value in the first η table than in the second η table except for a case where the forgetting factor η is 1. Accordingly, in a case where the forgetting factor η is determined based on the first η table in step ST16, the forgetting factor η becomes smaller and the reflection amount of the current value of the adaptive update filters W1 to H\hat{ }2 in the update value of the adaptive update filters W1 to H\hat{ }2 in the adaptive update process becomes smaller than in a case where the forgetting factor η is determined based on the second η table in step ST18. Accordingly, in a case where the microphone signal m is being used as the reference signal r, the reflection amount of the current value of the adaptive update filters W1 to H\hat{ }2 in the update value of the adaptive update filters W1 to H\hat{ }2 in the adaptive update process is smaller than in a case where the microphone signal m is not being used as the reference signal r.

In a case where the reference fluctuation TL set based on the fluctuation ΔL of the microphone signal m is within the prescribed range in the first η table, the forgetting factor η becomes continuously smaller as the reference fluctuation TL increases. Accordingly, as the fluctuation ΔL of the microphone signal m increases, the forgetting factor η becomes smaller, and the reflection amount of the current value of the adaptive update filters W1 to H\hat{ }2 in the update value of the adaptive update filters W1 to H\hat{ }2 in the adaptive update process becomes smaller. This increases the attenuation of the adaptive update filters W1 to H\hat{ }2, thereby reducing the canceling sound y.

In a case where the reference fluctuation TL is less than a reference value Q3 in the second η table, the forgetting factor η is kept at 1. In a case where the reference fluctuation TL is equal to or greater than the reference value Q3 and is less than a reference value Q4 that is greater than the reference value Q3 in the second η table, the forgetting factor η is kept at a value smaller than 1. In a case where the reference fluctuation TL is equal to or greater than the reference value Q4 in the second η table, the forgetting factor η is kept at 1.

The range where the forgetting factor η is kept at a value smaller than 1 (the range where the reference fluctuation TL is equal to or greater than the reference value Q3 and less than the reference value Q4) in the second η table partially overlaps with the range where the step size parameter μ becomes continuously smaller (the range where the reference fluctuation TL is equal to or greater than the reference value P3 and less than the reference value P4) in the second μ table. Accordingly, as the step size parameter μ becomes smaller continuously and thus the update amount of the adaptive update filters W1 to H\hat{ }2 becomes gradually smaller, the reflection amount of the current value of the adaptive update filters W1 to H\hat{ }2 in the update value of the adaptive update filters W1 to H\hat{ }2 in the adaptive update process decreases.

The range where the forgetting factor η is kept at 1 (the range where the reference fluctuation TL is equal to or greater than the reference value Q4) in the second η table partially overlaps with the range where the step size parameter μ is 0 (the range where the reference fluctuation TL is equal to or greater than the reference value P4) in the second μ table. Accordingly, even if the update amount of the adaptive update filters W1 to H\hat{ }2 becomes 0, the canceling sound output process continues.

### Execution Example 1 of the Second Switching Control

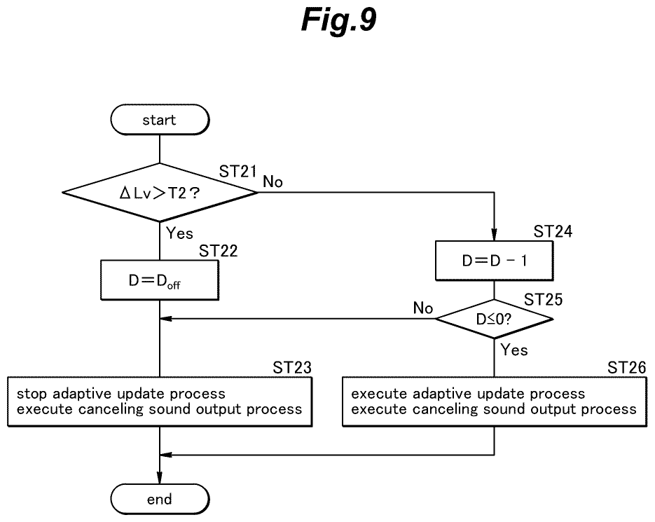

With reference to FIG. 9, when the second switching control starts, the process control unit 22 acquires the fluctuation ΔLv of the acceleration signal x from the fluctuation calculation unit 21 and determines whether the fluctuation ΔLv of the acceleration signal x exceeds a second threshold T2 (step ST21).

In a case where the fluctuation ΔLv of the acceleration signal x exceeds the second threshold T2 (step ST21: Yes), the process control unit 22 determines that an instantaneous vibration component has mixed into the acceleration signal x and sets the count value D to D_{off} (step ST22).

Next, the process control unit 22 stops the adaptive update process to prevent the adaptive update filters W1 to H\hat{ }2 from being adaptively updated based on the acceleration signal x into which the instantaneous vibration component has mixed. Further, the process control unit 22 executes the canceling sound output process with the control filters W1, W2 set as fixed filters (with the adaptive update of the control filters W1, W2 stopped), thereby causing the speaker 12 to output the canceling sound y (step ST23). Accordingly, it is possible to reduce the noise d based on road surface vibrations (the noise d that is the control target of the noise reduction device 1) and to maintain the maximum noise reduction performance even if the instantaneous vibration component has mixed into the acceleration signal x.

In a case where the fluctuation ΔLv of the acceleration signal x is equal to or less than the second threshold T2 (step ST21: No), the process control unit 22 subtracts 1 from the count value D (step ST24) and determines whether the count value D is equal to or less than 0 (step ST25).

In a case where the count value D is not equal to or less than 0 (step ST25: No), the process control unit 22 stops the adaptive update process and executes the canceling sound output process with the control filters W1, W2 set as fixed filters, thereby causing the speaker 12 to output the canceling sound y (step ST23).

In a case where the count value D is equal to or less than 0 (step ST25: Yes), the process control unit 22 adaptively updates the adaptive update filters W1 to H\hat{ }2 by executing the adaptive update process. The process control unit 22 also executes the canceling sound output process to cause the speaker 12 to output the canceling sound y (step ST26).

### Execution Example 2 of the Second Switching Control

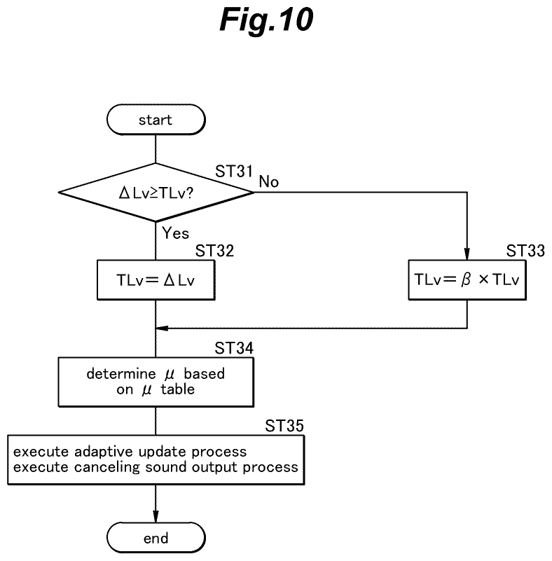

With reference to FIG. 10, when the second switching control starts, the process control unit 22 acquires the fluctuation ΔLv of the acceleration signal x from the fluctuation calculation unit 21 and determines whether the fluctuation ΔLv of the acceleration signal x is equal to or more than a reference fluctuation TLv (step ST31).

In a case where the fluctuation ΔLv of the acceleration signal x is equal to or more than the reference fluctuation TLv (step ST31: Yes), the process control unit 22 sets the reference fluctuation TLv to the fluctuation ΔLv (step ST32).

In a case where the fluctuation ΔLv of the acceleration signal x is less than the reference fluctuation TLv (step ST31: No), the process control unit 22 sets the reference fluctuation TLv to β×TLv (step ST33).

Next, the process control unit 22 determines the step size parameter μ based on the reference fluctuation TLv set in step ST32 or step ST33 and a u table showing the relationship between the reference fluctuation TLv and the step size parameter μ (step ST34). The u table will be described in detail later.

Next, the process control unit 22 adaptively updates the adaptive update filters W1 to H\hat{ }2 by executing the adaptive update process using the step size parameter μ set in step ST34 (see the above formulas (1) to (6)). At this time, the forgetting factor η may be set to 1 so that the output of the canceling sound y from the speaker 12 continues. Further, the process control unit 22 executes the canceling sound output process using the control filters W1, W2 that have been adaptively updated by the adaptive update process, thereby causing the speaker 12 to output the canceling sound y (step ST35).

As described above, the process control unit 22 sets the reference fluctuation TLv based on the fluctuation ΔLv of the acceleration signal x, determines the step size parameter μ based on the reference fluctuation TLv, and executes the adaptive update process using the step size parameter μ. Accordingly, the update amount of the adaptive update filters W1 to H\hat{ }2 in the adaptive update process (the second term on the right-hand side of the above formulas (1) to (6)) is changed according to the fluctuation ΔLv of the acceleration signal x.

### <μ Table>

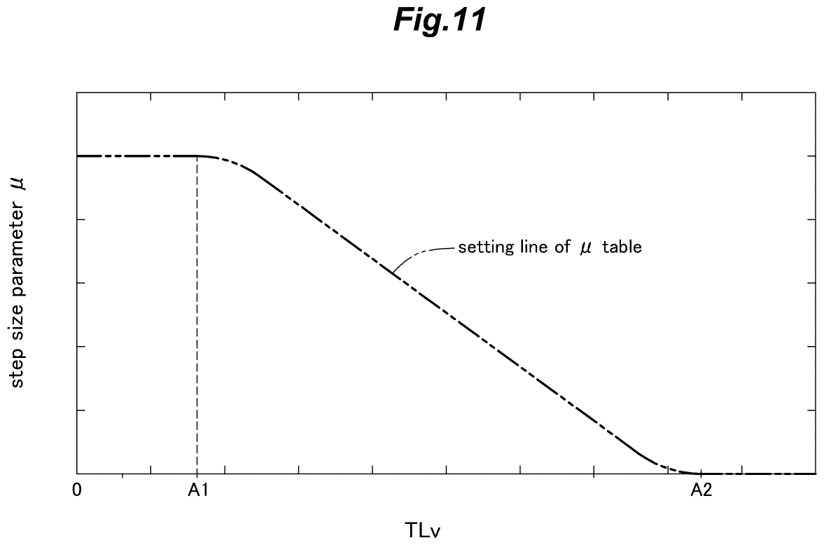

With reference to FIG. 11, in a case where the reference fluctuation TLv is less than a reference value A1 in the u table, the step size parameter μ is kept at the maximum value thereof. In a case where the reference fluctuation TLv is equal to or greater than the reference value A1 and is less than a reference value A2 that is greater than the reference value A1 in the μ table, the step size parameter μ becomes smaller as the reference fluctuation TLv increases. In a case where the reference fluctuation TLv is equal to or greater than the reference value A2 in the μ table, the step size parameter μ is kept at 0.

In a case where the reference fluctuation TLv set based on the fluctuation ΔLv of the acceleration signal x is within the prescribed range in the μ table, the step size parameter μ becomes continuously smaller as the reference fluctuation TLv becomes larger. Accordingly, as the fluctuation ΔLv of the acceleration signal x increases, the step size parameter μ decreases continuously, and the update amount of the adaptive update filters W1 to H\hat{ }2 in the adaptive update process decreases continuously.

### Effects

The noise reduction device 1 is designed so that the control effect thereof gets higher in the vicinity of the microphone 13. Considering this, according to the present embodiment, the microphone 13 is installed in the headrest 9C of the occupant seat 9. This allows the head of the occupant to be brought closer to the microphone 13, thereby enhancing the control effect that the occupant can feel.

On the other hand, if the microphone 13 is installed in the headrest 9C of the occupant seat 9, the position of the microphone 13 changes significantly and thus the transfer function C of the secondary path from the speaker 12 to the microphone 13 changes significantly in a case where the front-and-rear position of the occupant seat 9 is adjusted or the seat back 9B of the occupant seat 9 is reclined. Accordingly, the difference between the transfer function C of the secondary path and the secondary path filter C\hat{ }1, C\hat{ }2 becomes large, and thus the noise reduction device 1 may not be able to sufficiently reduce the noise d, or the noise d may be amplified. Considering this, the controller 15 adaptively updates the secondary path filter C\hat{ }1, C\hat{ }2. Accordingly, in a case where the transfer function C of the secondary path changes, the secondary path filter C\hat{ }1, C\hat{ }2 can change according to the change in the transfer function C. Accordingly, the noise reduction device 1 can sufficiently reduce the noise d and suppress the amplification of the noise d.

By the way, when the microphone 13 is installed in the headrest 9C of the occupant seat 9, the microphone 13 gets closer to the mouth of the occupant, which makes it easier for the microphone 13 to pick up the conversation sound of the occupant. In other words, the sound component is more likely to mix into the microphone signal m. When the microphone signal m into which the sound component has mixed is used as the reference signal r, the control signal u is generated based on the reference signal r into which the sound component has mixed, and the sound component may also mix into the canceling sound y output based on the control signal u. Accordingly, an acoustic echo may occur in the vehicle cabin 8, which may cause discomfort of the occupant. Considering this, in a case where the microphone signal m is being used as the reference signal r, the controller 15 stops the adaptive update process and the canceling sound output process (see the execution example 1 of the first switching control). Alternatively, in a case where the microphone signal m is being used as the reference signal r, the controller 15 reduces the update amount of the adaptive update filters W1 to H\hat{ }2 in the adaptive update process, and reduces the reflection amount of the current value of the adaptive update filters W1 to H\hat{ }2 in the update value of the adaptive update filters W1 to H\hat{ }2 in the adaptive update process (see the execution example 2 of the first switching control). Accordingly, it is possible to prevent the control signal u from being generated based on the reference signal r into which the sound component has mixed. Accordingly, it is possible to suppress the occurrence of the acoustic echo in the vehicle cabin 8 and stably reduce the noise d.

Further, in a case where the travel conditions (for example, the road surface conditions) of the vehicle 3 do not change, the level of the road noise does not change significantly, but the level of the conversation sound changes significantly. Using this principle, in a case where the fluctuation ΔL of the microphone signal m (i.e., the fluctuation of the integrated value of the amplitude of the microphone signal m for each prescribed period) exceeds the first threshold T1, the controller 15 determines that the sound component has mixed into the microphone signal m. Accordingly, it is possible to accurately detect whether the sound component has mixed into the microphone signal m (whether the acoustic echo is likely to occur) based on the fluctuation ΔL of the microphone signal m. Accordingly, it is possible to more effectively suppress the occurrence of the acoustic echo in the vehicle cabin 8 and more stably reduce the noise d.

By the way, when the vehicle 3 goes over a bump, a road joint, a road hump, and the like, large vibrations are momentarily input from the road surface to the vehicle 3, which may cause the instantaneous vibration component to mix into the acceleration signal x. If the adaptive update filters W1 to H\hat{ }2 are adaptively updated based on the acceleration signal x into which the instantaneous vibration component has mixed, the value of the adaptive update filters W1 to H\hat{ }2 may deviate from the value appropriate for the flat road surface, which may temporarily reduce the noise reduction performance on a flat road surface. Considering this, in a case where the fluctuation ΔLv of the acceleration signal x exceeds the second threshold T2 (in a case where the instantaneous vibration component has mixed into the acceleration signal x), the controller 15 stops the adaptive update process (see the execution example 1 of the second switching control). Alternatively, the controller 15 reduces the update amount of the adaptive update filters W1 to H\hat{ }2 in the adaptive update process as the fluctuation ΔLv of the acceleration signal x increases (see the execution example 2 of the second switching control). This avoids the undesired adaptive update of the adaptive update filters W1 to H\hat{ }2 (the adaptive update based on the acceleration signal x into which the instantaneous vibration component has mixed), thereby maintaining the noise reduction performance on the flat road surface.

### Modified Embodiment

In the above embodiment, the controller 15 switches the operation of the adaptive update process and the canceling sound output process according to the fluctuation ΔL of the microphone signal m and the fluctuation ΔLv of the acceleration signal x. In another embodiment, the controller 15 may switch the operation of the adaptive update process and the canceling sound output process according to only one of the fluctuation ΔL of the microphone signal m and the fluctuation ΔLv of the acceleration signal x. Further, in another embodiment, the controller 15 may switch the operation of only one of the adaptive update process and the canceling sound output process according to the fluctuation ΔL of the microphone signal m and/or the fluctuation ΔLv of the acceleration signal x.

In the above embodiment, the value of the forgetting factor η is changed in the second η table (then table in a case where the microphone signal m is not being used as the reference signal r). In another embodiment, the value of the forgetting factor η may be fixed to 1 in the second η table. Alternatively, in a case where the microphone signal m is not being used as the reference signal r, the value of the forgetting factor η may be fixed to 1 without setting the second η table.

In the above embodiment, the fluctuation ΔL of the microphone signal m is the fluctuation of the integrated value of the amplitude of the microphone signal m for each prescribed period. In another embodiment, the fluctuation ΔL of the microphone signal m may be a value other than the fluctuation of the integrated value of the amplitude of the microphone signal m for each prescribed period (for example, the fluctuation of the average value of the amplitude of the microphone signal m for each prescribed period). This also applies to the fluctuation ΔLv of the acceleration signal x.

In the above embodiment, the controller 15 adaptively updates the adaptive update filters W1 to H\hat{ }2 using the above formulas (1) to (6). However, the above formulas (1) to (6) are merely examples of formulas used for the adaptive update of the adaptive update filters W1 to H\hat{ }2. According to another embodiment, the controller 15 may adaptively update the adaptive update filters W1 to H\hat{ }2 using formulas other than the above formulas (1) to (6). For example, the controller 15 may use the following formulas (9) to (11) instead of the above formulas (4) to (6) (details are omitted, but similar substitutions are possible for the above formulas (1) to (3)).

$$W 2 ( t + 1 ) = η W 2 ( t ) - {μ}_{W} ( t ) e ( t ) ( r ( t ) * \hat{C} 2 ( t ) ) \qquad ( 9 )$$

$$\hat{C} 2 ( t + 1 ) = η \hat{C} 2 ( t ) + {μ}_{HC} ( t ) {e}_{v} 2 ( t ) ( r ( t ) * W 2 ( t ) ) \qquad ( 10 )$$

$$\hat{H} 2 ( t + 1 ) = η \hat{H} 2 ( t ) + {μ}_{HC} ( t ) {e}_{v} 2 ( t ) r ( t ) \qquad ( 11 )$$

μ_{W}(t) in the above formula (9) is represented by the following formula (12), and μ_{HC}(t) in the above formulas (10) and (11) is represented by the following formula (13).

$${μ}_{W} ( t ) = μ \frac{\vert {ρ}_{W} ( t ) \vert + β}{‖ r ( t ) * \hat{C} 2 ( t ) ‖ + σ} \qquad ( 12 )$$

$${μ}_{HC} ( t ) = μ \frac{\vert {ρ}_{HC} ( t ) \vert + β}{‖ r ( t ) ‖ + ‖ r ( t ) * W 2 ( t ) ‖ + σ} \qquad ( 13 )$$

“β” and “σ” in the above formulas (12) and (13) represent small positive numbers. ρ_{W}(t) in the above formula (12) is represented by the following formula (14), and ρ_{HC}(t) in the above formula (13) is represented by the following formula (15).

$${ρ}_{W} ( t ) = λ {ρ}_{W} ( t ) + ( 1 - λ ) {e ( t )}^{2} \qquad ( 14 )$$

$${ρ}_{HC} ( t ) = λ {ρ}_{HC} ( t ) + ( 1 - λ ) {e}_{v} 2 {( t )}^{2} \qquad ( 15 )$$

In the above embodiment, the controller 15 uses the current value (W1(t), C\hat{ }1(t), H\hat{ }1(t), W2(t), C\hat{ }2(t), H\hat{ }2(t)) of the adaptive update filters W1 to H\hat{ }2 as the value of the adaptive update filters W1 to H\hat{ }2 before the adaptive update thereof. In another embodiment, the controller 15 may use the past value of the adaptive update filters W1 to H\hat{ }2 (for example, W1(t−1), C\hat{ }1(t−1), H\hat{ }1(t−1), W2(t−1), C\hat{ }2(t−1), H\hat{ }2(t−1)) as the value of the adaptive update filters W1 to H\hat{ }2 before the adaptive update thereof, or may use both the current value and the past value of the adaptive update filters W1 to H\hat{ }2.

In the above embodiment, the controller 15 includes a plurality of adaptive update filters W1 to H\hat{ }2. In another embodiment, the controller 15 may include only one adaptive update filter.

In the above embodiment, both the acceleration signal x and the microphone signal m are used as the reference signal. In another embodiment, only one of the acceleration signal x and the microphone signal m may be used as the reference signal.

In the above embodiment, the noise reduction device 1 is applied to the vehicle cabin 8 of the vehicle 3. In another embodiment, the noise reduction device 1 may be applied to the interior space of a moving object other than the vehicle 3 (for example, a ship or an aircraft), or the noise reduction device 1 may be applied to the interior space of a fixed object (for example, a house).

This concludes the description of the specific embodiments, but the present invention is not limited to the above embodiments or modified embodiments, and can be widely modified and implemented.

### Summary of Embodiments

According to one aspect, an active noise reduction device 1 comprises: a canceling sound outputter 12 configured to output a canceling sound y for canceling a noise d; a microphone 13 configured to generate a microphone signal m based on the noise d; and a controller 15 configured to control the canceling sound outputter 12 based on the microphone signal m, wherein the controller 15 includes at least one filter W1, C\hat{ }1, H\hat{ }1, W2, C\hat{ }2, H\hat{ }2 that can be adaptively updated, and the controller 15 is configured to: calculate a fluctuation ΔL of the microphone signal m based on the microphone signal m; and switch an operation of at least one of an adaptive update process and a canceling sound output process according to the fluctuation ΔL of the microphone signal m, the adaptive update process being a process to adaptively update the filter W1, C\hat{ }1, H\hat{ }1, W2, C\hat{ }2, H\hat{ }2, the canceling sound output process being a process to cause the canceling sound outputter 12 to output the canceling sound y.

According to this aspect, in a case where a sound component has mixed into the microphone signal m, it is possible to switch the operation of the adaptive update process and/or the canceling sound output process, thereby suppressing the adaptive update of the filter W1, C\hat{ }1, H\hat{ }1, W2, C\hat{ }2, H\hat{ }2 and the output of the canceling sound y based on the microphone signal m into which the sound component has mixed. Accordingly, it is possible to suppress the occurrence of acoustic echo.

Preferably, the controller 15 is configured to calculate, as the fluctuation ΔL of the microphone signal m, a fluctuation of an integrated value of an amplitude of the microphone signal m for each of prescribed periods.

According to this aspect, based on the fluctuation ΔL of the microphone signal m, it is possible to accurately detect whether the sound component has mixed into the microphone signal m (i.e., whether the acoustic echo is likely to occur).

Preferably, the controller 15 is configured to: determine whether the microphone signal m is being used as a reference signal r corresponding to the noise d; stop the adaptive update process and the canceling sound output process in a case where the microphone signal m is being used as the reference signal r; and stop the adaptive update process and execute the canceling sound output process in a case where the microphone signal m is not being used as the reference signal r.

According to this aspect, in a case where the microphone signal m is being used as the reference signal r, it is possible to suppress the occurrence of the acoustic echo by stopping the adaptive update process and the canceling sound output process. By contrast, in a case where the microphone signal m is not being used as the reference signal r, it is possible to maximize the noise reduction performance by stopping the adaptive update process while continuing the canceling sound output process.

Preferably, the controller 15 is configured to change an update amount of the filter W1, C\hat{ }1, H\hat{ }1, W2, C\hat{ }2, H\hat{ }2 in the adaptive update process according to the fluctuation ΔL of the microphone signal m.

According to this aspect, by changing the update amount of the filter W1, C\hat{ }1, H\hat{ }1, W2, C\hat{ }2, H\hat{ }2 according to the fluctuation ΔL of the microphone signal m, it is possible to suppress the occurrence of the acoustic echo while maximizing the noise reduction performance.

Preferably, the controller 15 is configured to: determine whether the microphone signal m is being used as a reference signal r corresponding to the noise d; and reduce the update amount of the filter W1, C\hat{ }1, H\hat{ }1, W2, C\hat{ }2, H\hat{ }2 in the adaptive update process in a case where the microphone signal m is being used as the reference signal r as compared to a case where the microphone signal m is not being used as the reference signal r.

According to this aspect, in a case where the microphone signal m is being used as the reference signal r, it is possible to suppress the occurrence of the acoustic echo by reducing the update amount of the filter W1, C\hat{ }1, H\hat{ }1, W2, C\hat{ }2, H\hat{ }2. By contrast, in a case where the microphone signal m is not being used as the reference signal r, it is possible to maximize the noise reduction performance by increasing the update amount of the filter W1, C\hat{ }1, H\hat{ }1, W2, C\hat{ }2, H\hat{ }2.

Preferably, the controller 15 is configured to change a reflection amount of a value of the filter W1, C\hat{ }1, H\hat{ }1, W2, C\hat{ }2, H\hat{ }2 before an adaptive update thereof in a value of the filter W1, C\hat{ }1, H\hat{ }1, W2, C\hat{ }2, H\hat{ }2 after the adaptive update thereof in the adaptive update process according to the fluctuation ΔL of the microphone signal m.

According to this aspect, by changing the reflection amount according to the fluctuation ΔL of the microphone signal m, it is possible to suppress the occurrence of the acoustic echo while maximizing the noise reduction performance.

Preferably, the controller 15 is configured to: determine whether the microphone signal m is being used as a reference signal r corresponding to the noise d; and reduce the reflection amount in the adaptive update process in a case where the microphone signal m is being used as the reference signal r as compared to a case where the microphone signal m is not being used as the reference signal r.

According to this aspect, in a case where the microphone signal m is being used as the reference signal r, it is possible to suppress the occurrence of the acoustic echo by reducing the reflection amount. By contrast, in a case where the microphone signal m is not being used as the reference signal r, it is possible to maximize the noise reduction performance by increasing the reflection amount.

Preferably, the controller 15 is configured to: determine whether the microphone signal m is being used as a reference signal r corresponding to the noise d; and reduce an update amount of the filter W1, C\hat{ }1, H\hat{ }1, W2, C\hat{ }2, H\hat{ }2 in the adaptive update process and reduce a reflection amount of a value of the filter W1, C\hat{ }1, H\hat{ }1, W2, C\hat{ }2, H\hat{ }2 before an adaptive update thereof in a value of the filter W1, C\hat{ }1, H\hat{ }1, W2, C\hat{ }2, H\hat{ }2 after the adaptive update thereof in the adaptive update process in a case where the microphone signal m is being used as the reference signal r as compared to a case where the microphone signal m is not being used as the reference signal r.

According to this aspect, in a case where the microphone signal m is being used as the reference signal r, it is possible to suppress the occurrence of the acoustic echo by reducing the update amount and the reflection amount of the filter W1, C\hat{ }1, H\hat{ }1, W2, C\hat{ }2, H\hat{ }2. By contrast, in a case where the microphone signal m is not being used as the reference signal r, it is possible to maximize the noise reduction performance by increasing the update amount and the reflection amount of the filter W1, C\hat{ }1, H\hat{ }1, W2, C\hat{ }2, H\hat{ }2.

According to another aspect, an active noise reduction device 1 comprises: a canceling sound outputter 12 configured to output a canceling sound y for canceling a noise d; an acceleration sensor 11 configured to generate an acceleration signal x based on the noise d; and a controller 15 configured to control the canceling sound outputter 12 based on the acceleration signal x, wherein the controller 15 includes at least one filter W1, C\hat{ }1, H\hat{ }1, W2, C\hat{ }2, H\hat{ }2 that can be adaptively updated, and the controller 15 is configured to: calculate a fluctuation ΔLv of the acceleration signal x based on the acceleration signal x; and switch an operation of at least one of an adaptive update process and a canceling sound output process according to the fluctuation ΔLv of the acceleration signal x, the adaptive update process being a process to adaptively update the filter W1, C\hat{ }1, H\hat{ }1, W2, C\hat{ }2, H\hat{ }2, the canceling sound output process being a process to cause the canceling sound outputter 12 to output the canceling sound y.

According to this aspect, in a case where an instantaneous vibration component has mixed into the acceleration signal x, it is possible to switch the operation of the adaptive update process and/or the canceling sound output process, thereby suppressing the adaptive update of the filter W1, C\hat{ }1, H\hat{ }1, W2, C\hat{ }2, H\hat{ }2 and the output of the canceling sound y based on the acceleration signal x into which the instantaneous vibration component has mixed. Accordingly, it is possible to maintain the noise reduction performance on a flat road surface.

Preferably, the controller 15 is configured to calculate, as the fluctuation ΔLv of the acceleration signal x, a fluctuation of an integrated value of an amplitude of the acceleration signal x for each of prescribed periods.

According to this aspect, based on the fluctuation ΔLv of the acceleration signal x, it is possible to accurately detect whether the instantaneous vibration component has mixed into the acceleration signal x (whether the noise reduction performance is likely to temporarily decrease on the flat road surface).

Preferably, the controller 15 is configured to: determine whether the fluctuation ΔLv of the acceleration signal x exceeds a threshold T2; and stop the adaptive update process and execute the canceling sound output process in a case where the fluctuation ΔLv of the acceleration signal x exceeds the threshold T2.

According to this aspect, in a case where the fluctuation ΔLv of the acceleration signal x exceeds the threshold T2, it is possible to suppress a temporary decrease in the noise reduction performance on the flat road surface by stopping the adaptive update process. On the other hand, it is possible to maximize the noise reduction performance by stopping the adaptive update process while continuing the canceling sound output process.

Preferably, the controller 15 is configured to change an update amount of the filter W1, C\hat{ }1, H\hat{ }1, W2, C\hat{ }2, H\hat{ }2 in the adaptive update process according to the fluctuation ΔLv of the acceleration signal x.

According to this aspect, by changing the update amount of the filters W1, C\hat{ }1, H\hat{ }1, W2, C\hat{ }2, H\hat{ }2 according to the fluctuation ΔLv of the acceleration signal x, it is possible to suppress a temporary decrease in the noise reduction performance on the flat road surface while maximizing the noise reduction performance.

1. An active noise reduction device, comprising:
a canceling sound outputter configured to output a canceling sound for canceling a noise;
a microphone configured to generate a microphone signal based on the noise; and
a controller configured to control the canceling sound outputter based on the microphone signal,
wherein the controller includes at least one filter that can be adaptively updated, and
the controller is configured to:
calculate a fluctuation of the microphone signal based on the microphone signal; and
switch an operation of at least one of an adaptive update process and a canceling sound output process according to the fluctuation of the microphone signal, the adaptive update process being a process to adaptively update the filter, the canceling sound output process being a process to cause the canceling sound outputter to output the canceling sound.

2. The active noise reduction device according to claim 1, wherein the controller is configured to calculate, as the fluctuation of the microphone signal, a fluctuation of an integrated value of an amplitude of the microphone signal for each of prescribed periods.

3. The active noise reduction device according to claim 1, wherein the controller is configured to:
determine whether the microphone signal is being used as a reference signal corresponding to the noise;
stop the adaptive update process and the canceling sound output process in a case where the microphone signal is being used as the reference signal; and
stop the adaptive update process and execute the canceling sound output process in a case where the microphone signal is not being used as the reference signal.

4. The active noise reduction device according to claim 1, wherein the controller is configured to change an update amount of the filter in the adaptive update process according to the fluctuation of the microphone signal.

5. The active noise reduction device according to claim 4, wherein the controller is configured to:
determine whether the microphone signal is being used as a reference signal corresponding to the noise; and
reduce the update amount of the filter in the adaptive update process in a case where the microphone signal is being used as the reference signal as compared to a case where the microphone signal is not being used as the reference signal.

6. The active noise reduction device according to claim 1, wherein the controller is configured to change a reflection amount of a value of the filter before an adaptive update thereof in a value of the filter after the adaptive update thereof in the adaptive update process according to the fluctuation of the microphone signal.

7. The active noise reduction device according to claim 6, wherein the controller is configured to:
determine whether the microphone signal is being used as a reference signal corresponding to the noise; and
reduce the reflection amount in the adaptive update process in a case where the microphone signal is being used as the reference signal as compared to a case where the microphone signal is not being used as the reference signal.

8. The active noise reduction device according to claim 1, wherein the controller is configured to:
determine whether the microphone signal is being used as a reference signal corresponding to the noise; and
reduce an update amount of the filter in the adaptive update process and reduce a reflection amount of a value of the filter before an adaptive update thereof in a value of the filter after the adaptive update thereof in the adaptive update process in a case where the microphone signal is being used as the reference signal as compared to a case where the microphone signal is not being used as the reference signal.

9. An active noise reduction device, comprising:
a canceling sound outputter configured to output a canceling sound for canceling a noise;
an acceleration sensor configured to generate an acceleration signal based on the noise; and
a controller configured to control the canceling sound outputter based on the acceleration signal,
wherein the controller includes at least one filter that can be adaptively updated, and
the controller is configured to:
calculate a fluctuation of the acceleration signal based on the acceleration signal; and
switch an operation of at least one of an adaptive update process and a canceling sound output process according to the fluctuation of the acceleration signal, the adaptive update process being a process to adaptively update the filter, the canceling sound output process being a process to cause the canceling sound outputter to output the canceling sound.

10. The active noise reduction device according to claim 9, wherein the controller is configured to calculate, as the fluctuation of the acceleration signal, a fluctuation of an integrated value of an amplitude of the acceleration signal for each of prescribed periods.

11. The active noise reduction device according to claim 9, wherein the controller is configured to:
determine whether the fluctuation of the acceleration signal exceeds a threshold; and
stop the adaptive update process and execute the canceling sound output process in a case where the fluctuation of the acceleration signal exceeds the threshold.

12. The active noise reduction device according to claim 9, wherein the controller is configured to change an update amount of the filter in the adaptive update process according to the fluctuation of the acceleration signal.
